(19) United States
(12) Patent Application Publication
(10) Pub. No.: US 2004/0193650 A1
(43) Pub. Date: Sep. 30, 2004

(54) Image processing apparatus

(75) Inventors: Takeshi Funahashi, Kanagawa (JP); Shoji Hara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/808,382

(22) Filed: Mar. 25, 2004

(30) Foreign Application Priority Data
Mar. 28, 2003 (JP) 2003-091211
Mar. 28, 2003 (JP) 2003-091212

(51) Int. Cl. G06F 7/00

(52) U.S. Cl. 707/104.1

(57) ABSTRACT

An image processing apparatus includes: an image-processing history storing unit for storing details of image processing performed for a medical image of a patient to correspond to a name of the patient; an image acquisition unit for newly obtaining a name of a patient and a medical image in such a manner that they correspond to each other; an image-processing details extraction unit for extracting the details of image processing stored in the image-processing history storing unit to correspond to the name of the patient newly obtained by the image acquisition unit; and an image processing unit for performing image processing having details that are the same as the extracted details of image processing, for the medical image newly obtained by the image acquisition unit.

This patent application claims priority from Japanese patent applications Nos. 2003-091211 and 2003-091212 both filed on Mar. 28, 2003, the contents of which are incorporated herein by reference.

### BACKGROUND OF THE INVENTION

Field of the Invention

The present invention relates to an image processing apparatus. More particularly, the present invention relates to an image processing apparatus for performing image processing for a medical image.

Related Art

A medical image such as an X-ray, that can be used for diagnosis by a doctor, was conventionally reproduced as a hard copy of a photographic film on which the medical image was recorded. In recent years, such a medical image is recorded as digital data and is displayed by an image processing apparatus for diagnosis by the doctor. The doctor conducts diagnosis by examining the medical image while performing image processing such as an operation related to gray scales or a frequency for the medical image.

However, the doctor has to perform image processing for the medical image in the same way every time the doctor examines the medical image, even if the same kind of medical image is used. Moreover, in a case where the medical image to be examined is of a certain type for which the doctor does not have much experience, the doctor may perform image processing for that medical image inappropriately, thus causing wrong diagnosis.

Moreover, the doctor may examine the medical image while the medical image to be examined is displayed together with the previous medical image of the same patient that was taken on a different date. As a technique used in such examination, Japanese Patent Application Publications (Laid-Open) Nos. 2001-157667 and 2001-157675 disclose a technique in which the medical images of the same patient that were taken on different dates are displayed for examination on a display apparatus such as a monitor, for example. In this examination, a person who examines the medical image, such as the doctor, may change the way of image processing for every medical image so as to examine the medical image more easily.

However, according to the conventional technique described above, when a medical image of a certain patient is compared with a previous medical image of that patient and is examined, the medical image to be examined may be processed in a different way from the way in which the previous medical image were examined. This prevents an appropriate comparison and diagnosis.

### SUMMARY OF THE INVENTION

Therefore, it is an object of the present invention to provide an image processing apparatus, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, an image processing apparatus comprises: an image-processing history storing unit operable to store details of image processing performed for a medical image of a patient to correspond to a name of the patient; an image acquisition unit operable to newly obtain a name of a patient and a medical image in such a manner that they correspond to each other; an image-processing details extraction unit operable to extract the details of image processing stored in the image-processing history storing unit to correspond to the name of the patient newly obtained by the image acquisition unit; and an image processing unit operable to perform image processing having details that are the same as the details of image processing thus extracted, for the medical image newly obtained by the image acquisition unit.

The image-processing history storing unit may store the medical image of the patient in such a manner that the medical image correspond to the name of the patient and a name of a site of the patient, the image acquisition unit may further obtain a name of a site newly, and the image-processing details extraction unit may extract the details of image processing stored in the image-processing history storing unit to correspond to the name of the patient and the name of the site that were newly obtained by the image acquisition unit.

The image-processing history storing unit may store the details of image processing that was performed for the medical image when diagnosis based on the medical image was input in an electronic medical chart.

The image-processing history storing unit may store details of an operation related to a frequency that was performed for the medical image in order to diagnose a disease/injury of the patient, as the details of image processing.

The image-processing history storing unit may store a range of an intensity of brightness of the medical image that was selected for diagnosis of a disease/injury of the patient, as the details of image processing.

According to the second aspect of the present invention, an image processing apparatus comprises: an image-processing history storing unit operable to store details of image processing performed for a medical image of a patient in such a manner that the details of image processing correspond to a name of a disease/injury of the patient that was diagnosed; an image acquisition unit operable to newly obtain a name of a disease/injury and a medical image; an image-processing details extraction unit operable to extract the details of image processing stored in the image-processing history storing unit in such a manner that the details of image processing correspond to the name of the disease/injury newly obtained by the image acquisition unit; and an image processing unit operable to perform image processing having details that are the same as extracted the details of image processing, for the medical image newly obtained by the image acquisition unit.

The image-processing history storing unit may stores the details of image processing in such a manner that the details of image processing correspond to the name of the disease/injury as well as a name of a site, the image acquisition unit further may obtain a name of a site to correspond to the medical image newly obtained, and the image-processing details extraction unit may extract the details of image processing stored in the image-processing history storing unit, to correspond to the name of the disease/injury and the name of the site that were newly obtained by the image acquisition unit.

The image-processing history storing unit may store the details of image processing in such a manner that the details of image processing correspond to the name of the disease/injury as well as a type of the patient, the image acquisition unit may further obtain a type of a patient to correspond to the medical image newly obtained, and the image-processing details extraction unit may extract the details of image processing stored in the image-processing history storing unit, to correspond to the name of the disease/injury and the type of the patient that were newly obtained by the image acquisition unit.

The image-processing history storing unit may store the details of image processing in such a manner that the details of image processing correspond to the name of the disease/injury as well as a name of a doctor who performed the image processing, the image acquisition unit may further obtain a name of a doctor to correspond to the medical image newly obtained, and the image-processing details extraction unit may extract the details of image processing stored in the image-processing history storing unit, to correspond to the name of the disease/injury and the name of the doctor that were newly obtained by the image acquisition unit.

The image-processing details extraction unit may extract one way of image processing for which a number of used times is the largest, from a plurality of ways of image processing stored in the image-processing history storing unit to correspond to the name of the disease/injury newly obtained by the image acquisition unit.

The image-processing history storing unit may store the details of image processing when diagnosis based on the medical image was input in an electronic medical chart.

When an electronic medical chart was selected, the image acquisition unit may obtain the medical image and the name of the disease/injury that are attached to the selected electronic medical chart, the image-processing details extraction unit may extract the details of image processing that are stored to correspond to the name of the disease/injury newly obtained by the image acquisition unit from the electronic medical chart, from the image-processing history storing unit, and the image processing unit may perform image processing having details that are the same as those extracted, for the medical image newly obtained by the image acquisition unit from the electronic medical chart.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary structure of a medical network according to the first embodiment of the present invention.

FIG. 2 is an exemplary functional diagram of an image processing apparatus according to the first embodiment of the present invention.

FIG. 3 shows an exemplary data structure of an image-processing history storing unit of the image processing apparatus shown in FIG. 2.

FIG. 4 is a flowchart of an exemplary operation of the image processing apparatus shown in FIG. 2.

FIG. 5 shows an exemplary structure of a medical network according to the second embodiment of the present invention.

FIG. 6 is an exemplary functional diagram of an image processing apparatus according to the second embodiment of the present invention.

FIG. 7 shows an exemplary data structure of an image-processing history storing unit of the image processing apparatus shown in FIG. 6.

FIG. 8 is a flowchart of an exemplary operation of the image processing apparatus shown in FIG. 6.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

Embodiment 1

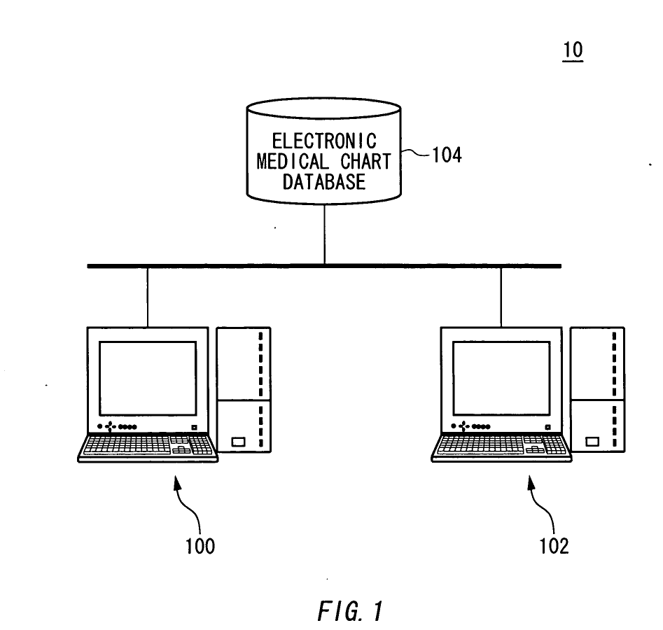

FIG. 1 shows an exemplary structure of a medical network 10 according to the first embodiment of the present invention. The medical network 10 includes one or more image processing apparatuses (two image processing apparatuses 100 and 102 in the example shown in FIG. 1) and an electronic medical chart database 104 that stores, for each patient, diagnosis information containing one or more medical images of the patient and provides the diagnosis information to the image processing apparatus.

The electronic medical chart database 104 stores a medical image obtained by various types of imaging modality, such as CT, MRI, CR, US, as digital data. The image processing apparatus 100 or 102 is placed in a doctor's office, a consultation room, a medical examination room or the like and displays diagnosis information of a patient from the electronic medical chart database 104 in accordance with an instruction from a doctor. The doctor then examines a medical image displayed on the image processing apparatus 100 or 102 while performing image processing for the medical image, thereby conducting diagnosis of a disease/injury of the patient.

For example, the doctor takes an X-ray of an affected site of the patient who has a fracture, and stores the X-ray in the electronic medical chart database 104 together with medical chart information of that patient. Then, the doctor obtains the X-ray and the medical chart information from the electronic medical chart database 104 by means of the image processing apparatus 100, and examines the X-ray while processing image processing for that X-ray, so as to conduct diagnosis. The image processing apparatus 100 stores the way of image processing, i.e., the details of image processing, performed by the doctor in such a manner that the details of image processing correspond to the name of the patient.

After that, when the same patient came to hospital again and a new X-ray of the affected site was taken for diagnosis, the image processing apparatus 100 automatically performs image processing for the new X-ray in the same way as the way of image processing for the previous X-ray of that patient and then displays the new X-ray. At this time, the image processing apparatus 100 searches for the details of image processing corresponding to that patient based on the name of that patient that was input by the doctor or included in the extracted medical chart information. Thus, the doctor can save the effort of performing image processing for the new X-ray. Moreover, because the doctor can examine the new X-ray for which image processing was performed in the same way as that performed for the previous X-ray, the doctor can compare the new X-ray and the previous X-ray appropriately so as to determine the degree of healing correctly.

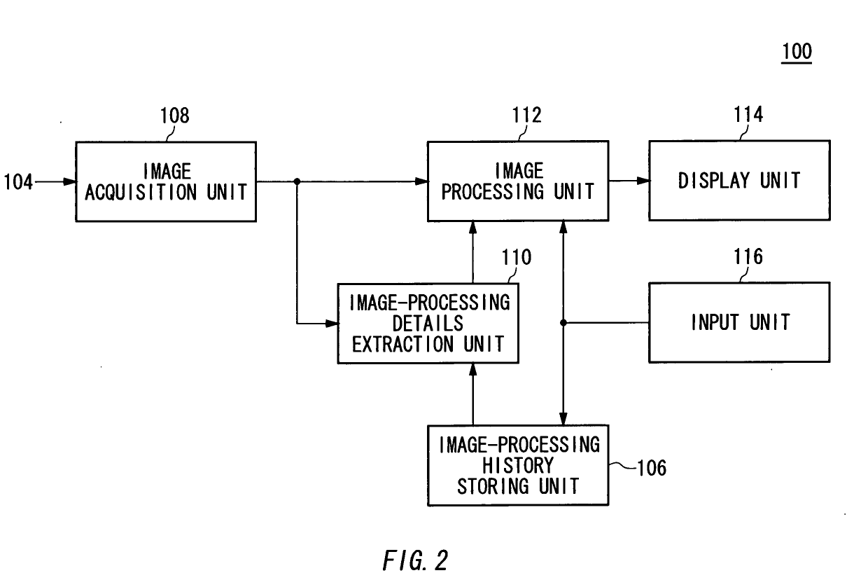

FIG. 2 is an exemplary functional diagram of the image processing apparatus 100 of the present embodiment. Since the image processing apparatuses 100 and 102 have the same structure, only the structure of the image processing apparatus 100 is described. The image processing apparatus 100 includes: an image-processing history storing unit 106 for storing details of image processing that was performed for a medical image; an image acquisition unit 108 for newly obtaining a medical image; an image-processing details extraction unit 110 for extracting the details of image processing stored in the image-processing history storing unit 106 based on information attached to the medical image newly obtained by the image acquisition unit 108; an image processing unit 112 for performing image processing that has the same details as those extracted by the image-processing details extraction unit 110, for the medical image newly obtained by the image acquisition unit 108 and then making that medical image be output; a display unit 114 for displaying the medical image for which the image processing was performed by the image processing unit 112; and an input unit 116 for inputting an instruction from the doctor.

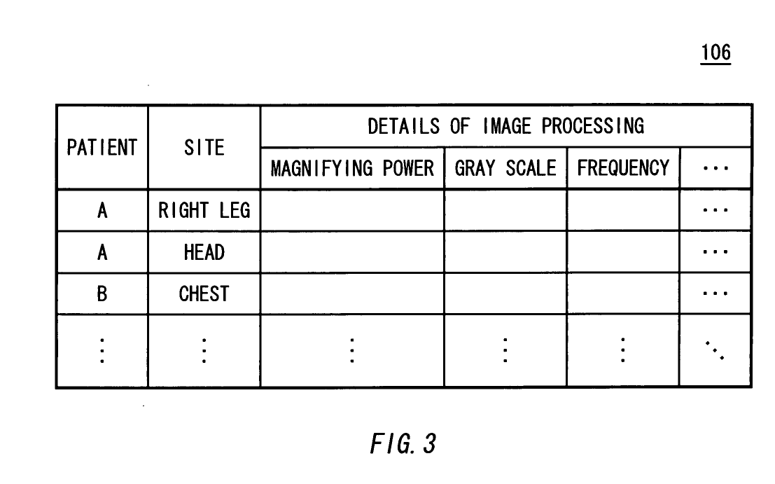

FIG. 3 shows an exemplary data structure of the image-processing history storing unit 106 according to the present embodiment. The image-processing history storing unit 106 stores the details of image processing that was performed for a medical image of a patient in such a manner that they correspond to the name of the patient and the name of the site of which the medical image was taken. Alternately, the image-processing history storing unit 106 may store medical-chart identifying information for identifying medical chart information or patient identifying information for identifying a patient, in place of the name of the patient. Moreover, the image-processing history storing unit 106 may store site identifying information for identifying the site, in place of the name of the site.

In the present embodiment, the details of image processing include a magnifying power in a magnifying operation and the details of operations related to the frequency, gray scale and the like, that were performed for a medical image by the doctor in order to conduct diagnosis. More specifically, as the details of image processing, a range of a spatial frequency enhanced in the medical image, a range of brightness enhanced in the medical image and the like are considered. Especially, in a case where the medical image is a three-dimensional image such as a CT image, the details of image processing include coordinates in a cross-section in MPR (Multi Planar Reconstruction), a stacking display speed when a plurality of medical images are displayed while being stacked, a projection direction in MIP (Maximum Intensity Projection), a format of tiles to be displayed, positions of various markings, a threshold value, a projection direction and color information of a 3D processing, and the like, for example.

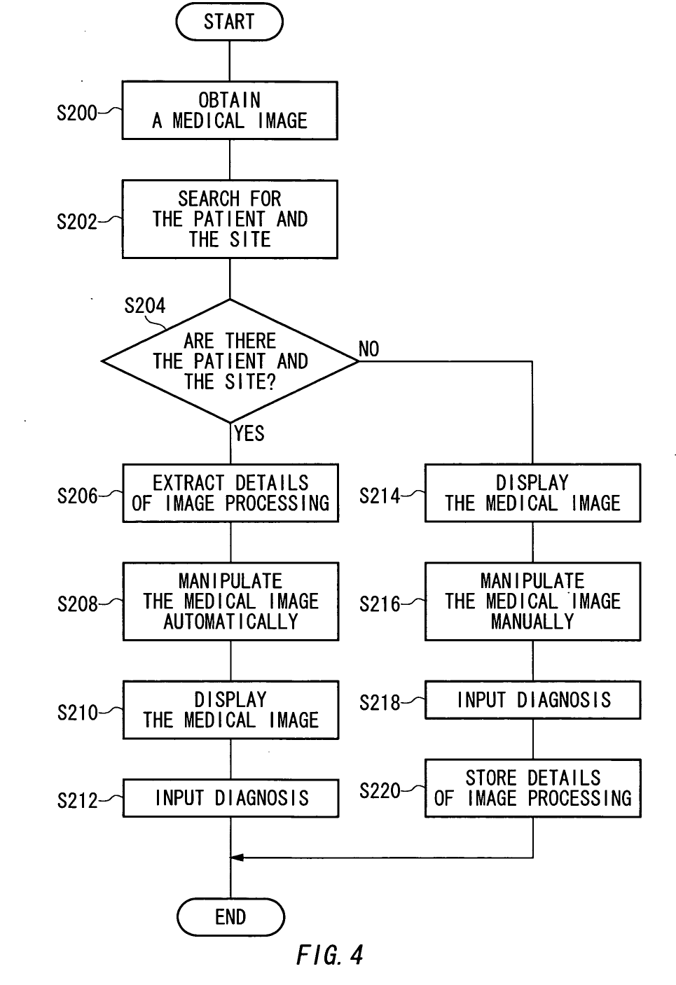

FIG. 4 is a flowchart of an exemplary operation of the image processing apparatus 100 according to the present embodiment. First, the image acquisition unit 108 newly obtains a medical image and information attached to the medical image, such as a patient's name and a site's name, from the electronic medical chart database 104 in such a manner that the medical image and the attached information correspond to each other (Step S200). The image-processing details extraction unit 110 searches for the patient's name and the site's name that were newly obtained by the image acquisition unit 108 in the image-processing history storing unit 106 (Step S202).

In a case where the image-processing history storing unit 106 does not store the patient's name and the site's name that were newly obtained by the image acquisition unit 108 (Step S204-N), the display unit 114 displays the medical image newly obtained by the image acquisition unit 108 (Step S214). The doctor manipulates the displayed medical image manually by using the input unit 116, while observing the displayed medical image (Step S216). The doctor then conducts diagnosis based on the examination of the medical image displayed by the display unit 214 and inputs the diagnosis in medical chart information by using the input unit 116 (Step S218). When the doctor inputted the diagnosis based on the examination of the medical image in the medical chart information, the image-processing history storing unit 106 stores the details of the image processing performed for that medical image in such a manner that the details of the image processing correspond to the patient's name and the site's name (Step S220).

In a case where the image-processing history storing unit 106 stores the patient's name and the site's name that were newly obtained by the image acquisition unit 108 (Step S204-Y), the image-processing details extraction unit 110 extracts the details of image processing that are stored in the image-processing history storing unit 106 to correspond to the patient's name and the site's name that were newly obtained by the image acquisition unit 108 (Step S206). The image processing unit 112 then automatically perform image processing having the same details as those of image processing thus extracted, for the medical image obtained by the acquisition unit 108 (Step S208). The display unit 114 displays the medical image for which the image processing was performed by the image processing unit 110 (Step S210). The doctor examines the displayed medical image, conducts diagnosis, and then inputs the diagnosis in the medical chart information by means of the input unit 116 (Step S212).

The display unit 114 may display the medical image obtained by the image acquisition unit 108 before image processing is performed. In this case, the display unit 114 may display the medical image during the image processing as needed, and the doctor may input various instructions related to the image processing, such as an instruction for stopping or pausing the image processing or the like, by means of the input unit 116. Moreover, the doctor may further manipulate the medical image for which the image processing has been performed, manually by using the input unit 116.

According to the image processing apparatus 100 of the present embodiment, in a case where medical images of an affected site of the same patient are taken on different dates and the doctor determines the progress of the disease or the degree of healing of the disease/injury with the passage of time, the image processing apparatus 100 automatically performs image processing for the medical image to be examined in the same way as that of image processing performed for the previous medical image of that affected site of that patient. Therefore, the effort of performing image processing in the same way every time a medical image is newly taken can be saved, and image processing can be automatically performed for the medical image to be examined in an appropriate manner. Moreover, image processing can be performed in the same way for a plurality of medical images that were taken on different dates. Therefore, it is possible to appropriately compare the medical images, thus correctly determining the degree of healing or the like.

The image processing apparatus 100 according to the present embodiment is effective in a case where a medical image taken in a regular medical examination such as an examination for cancer is compared with a previous medical image taken in the previous medical examination; a case where, for a patient for which a shadow characteristic of lung cancer, breast cancer, brain cancer or the like was found, the doctor examines the size change of that shadow; a case where the doctor examines the degree of healing of pneumonia, pulmonary edema or the like, that is, the degree of improvement of interstitial shadow in a lung; a case where the doctor examines the degree of healing of a fracture, that is, the degree of mending of the broken shadows in the site of the fracture; and a case where the doctor examines the progress of osteoporosis, that is, the change of the density of a trabecular bone, for example. Especially, in a case where the medical image is a three-dimensional image such as a CT image, the image processing apparatus 100 of the present embodiment is effective in the comparison of the medical image taken in a regular medical examination such as an examination for cancer with the medical image in the previous medical examination, and in the examination of the size change of the shadow that is characteristic of cancer that was already found.

Embodiment 2

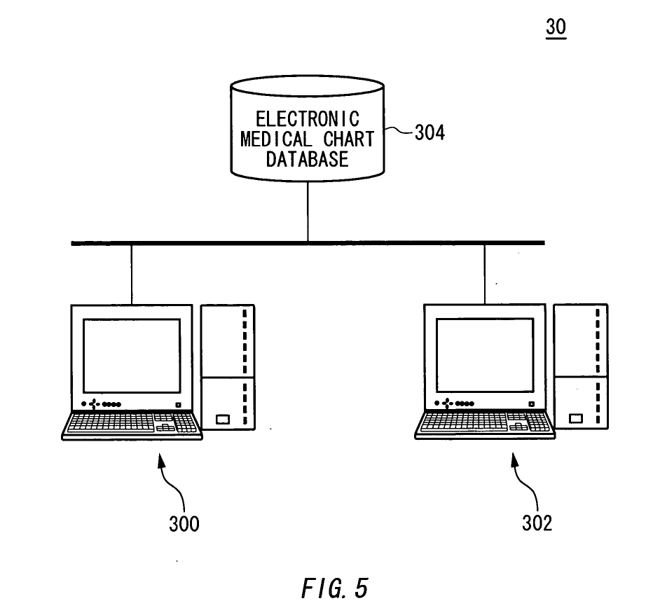

FIG. 5 shows an exemplary structure of a medical network 30 according to the second embodiment of the present invention. The medical network 30 includes one or more image processing apparatuses (two image processing apparatuses 300 and 302 in the example shown in FIG. 5) and an electronic medical chart database 304 that stores, for each patient, diagnosis information containing one or more medical images of the patient and provides the diagnosis information to the image processing apparatus.

The electronic medical chart database 304 stores a medical image obtained by various types of imaging modality, such as CT, MRI, CR, US, as digital data. The image processing apparatus 300 or 302 is placed in a doctor's office, a consultation room, a medical examination room or the like and displays diagnosis information of a patient from the electronic medical chart database 304 in accordance with an instruction from a doctor. The doctor then examines a medical image displayed on the image processing apparatus 300 or 302 while performing image processing for the medical image, thereby conducting diagnosis of a disease/injury of the patient.

The doctor takes an X-ray of an affected site of a patient, for example, an X-ray of an ankle of a patient who has a fracture of the ankle, and stores the taken X-ray in the electronic medical chart database 304 together with medical chart information that describes predicted diagnosis of the fracture of the ankle. After that, the doctor obtains the X-ray and the medical chart information from the electronic medical chart database 304 by means of the image processing apparatus 300. The image processing apparatus 300 stores a way of image processing that is suitable for an X-ray of a broken ankle therein as details of image processing, and extracts the details of image processing based on the predicted diagnosis of the fracture of the ankle described in the medical chart information. Then, the image processing apparatus 300 automatically performs image processing having details that are the same as those extracted based on the predicted diagnosis, for the X-ray obtained from the electronic medical chart database 304, and thereafter displays the X-ray for which the image processing has been performed.

As described above, since a medical image is displayed after being automatically manipulated in accordance with the details of image processing that were determined in advance, the medical image can be displayed appropriately, irrespective of the experience of the doctor or the like. Therefore, it is possible to prevent wrong diagnosis such as oversight of the affected site caused by inappropriate image processing. Moreover, the doctor can save the effort for performing image processing in the same or similar way every time the same type of medical image is examined.

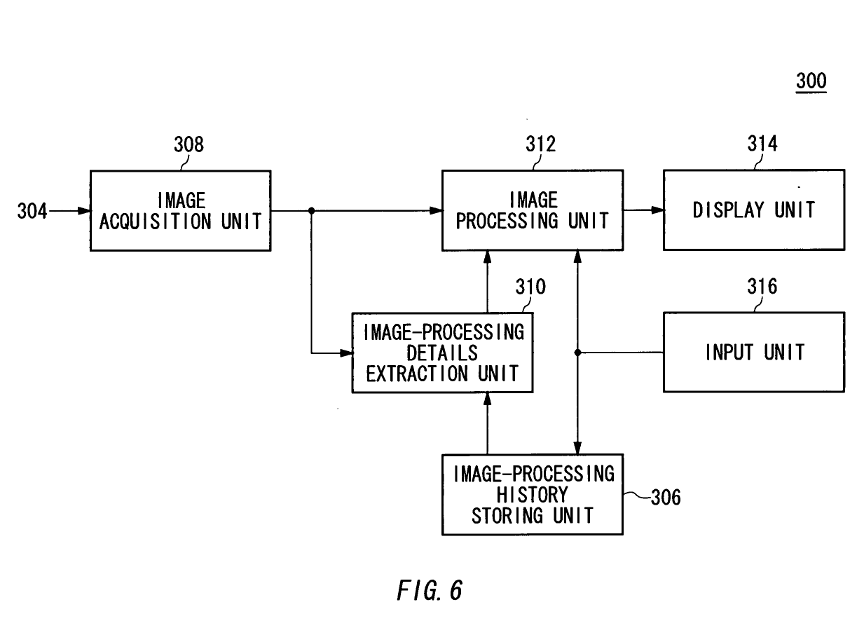

FIG. 6 is an exemplary functional diagram of the image processing apparatus 300 according to the present embodiment. The image processing apparatus 300 includes an image-processing history storing unit 306 that stores details of image processing that was performed for a medical image; an image acquisition unit 308 that newly obtains a medical image; an image-processing details extraction unit 310 that extracts details of image processing stored in the image-processing history storing unit 306 based on information attached to the medical image newly obtained; an image processing unit 312 that performs image processing having details that are the same as those extracted by the image-processing details extraction unit 310, for the medical image newly obtained by the image acquisition unit 308; a display unit 314 that displays the medical image for which the image processing was performed by the image processing unit 312; and an input unit 316 that inputs an instruction from a doctor.

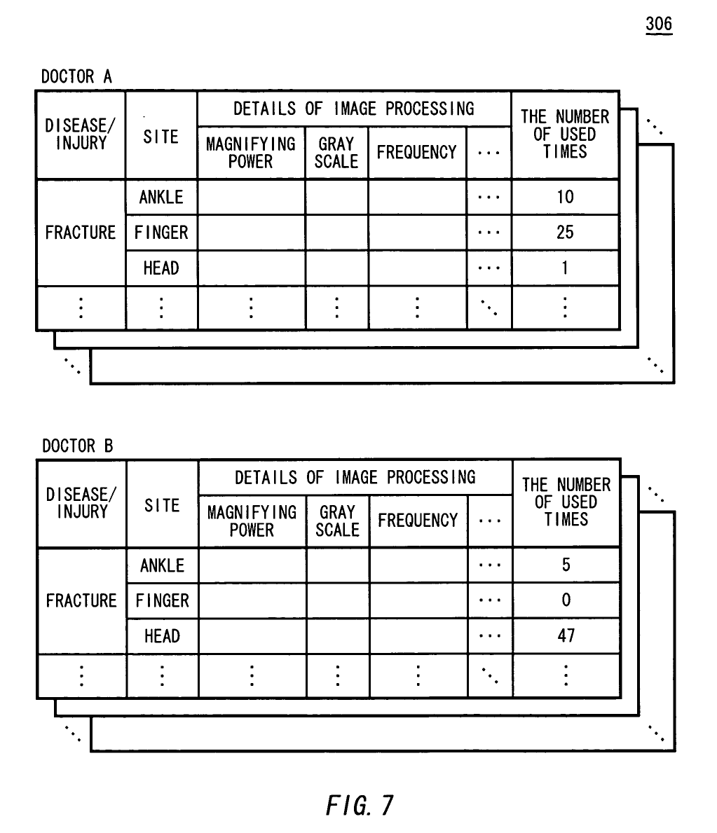

FIG. 7 shows an exemplary data structure of the image-processing history storing unit 306 in the present embodiment. The image-processing history storing unit 306 stores details of image processing that was performed for a medical image of an affected site of a patient in such a manner that the details of image processing correspond to the name of the disease/injury that was diagnosed for that patient and the name of the affected site. The image-processing history storing unit 306 also stores the number of the used times of the details of image processing in such a manner that the number corresponds to the details of image processing. Moreover, the image-processing history storing unit 306 may store the details of image processing performed for the medical image so as to correspond to the name of the doctor who performed the image processing having those details for that medical image. In addition, the image-processing history storing unit 306 may store the details of image processing performed for the medical image so as to correspond to the type of the patient of that medical image. The type of the patient is weight, age, or sex, for example. The image-processing history storing unit 306 may store details of image processing for each weight or weight range, each age or age range, or each sex.

By storing the details of image processing not only for each disease/injury and each affected site but also for each weight or weight range, each age or age range, or each sex, image processing can be performed for medical images of various patients more appropriately. Moreover, by storing the details of image processing for every doctor, image processing can be performed in accordance with the preference of the doctor.

In the present embodiment, the details of image processing include a magnifying power in a magnifying operation and the details of operations related to the frequency, gray scale and the like, that were performed for a medical image by the doctor in order to conduct diagnosis. More specifically, as the details of image processing, a range of a spatial frequency enhanced in the medical image, a range of brightness enhanced in the medical image and the like are considered. Especially, in a case where the medical image is a three-dimensional image such as a CT image, the details of image processing include coordinates in a cross-section in MPR (Multi Planar Reconstruction), a stacking display speed when a plurality of medical images are displayed while being stacked, a projection direction in MIP (Maximum Intensity Projection), a format of tiles to be displayed, positions of various markings, a threshold value, a projection direction and color information of a 3D processing, and the like, for example.

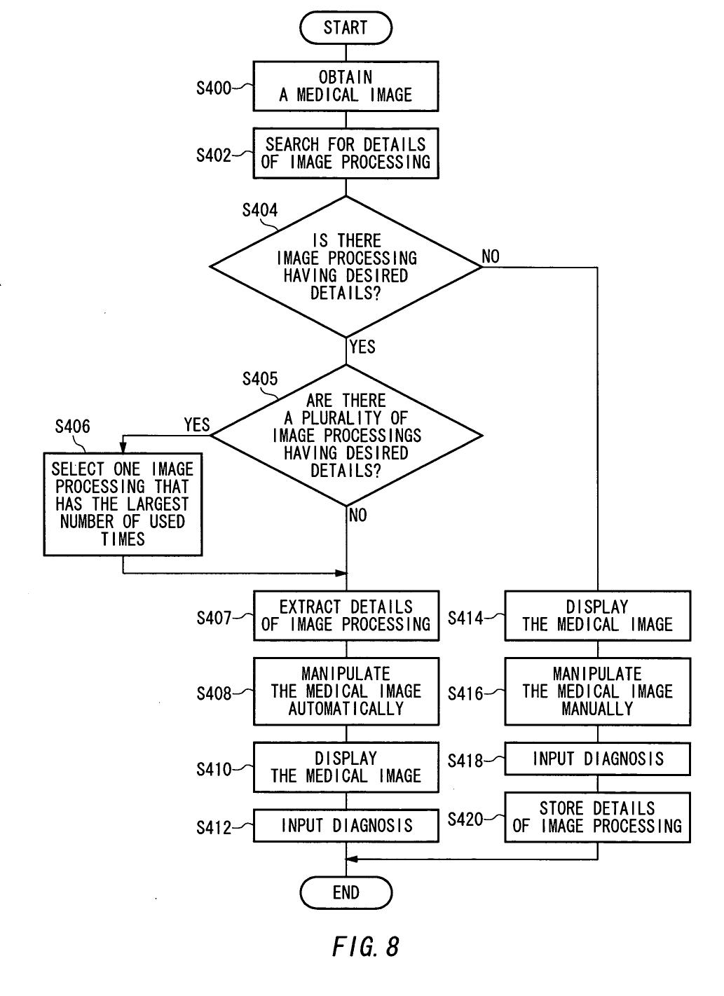

FIG. 8 is a flowchart of an exemplary operation of the image processing apparatus 300 according to the present embodiment. The image acquisition unit 308 obtains a medical image and information attached to that medical image such as the name of the disease/injury, the name of the site, the name of the doctor, the type of the patient, from the electronic medical chart database 304 in such a manner that the medical image and the attached information correspond to each other (Step S400). For example, when an electronic medical chart is selected in the image processing apparatus 300, the image acquisition unit 308 obtains the medical image and the attached information that are attached to the electronic medical chart thus selected in such a manner that the medical image and the attached information correspond to each other.

The image-processing details extraction unit 310 searches for details of image processing in the image-processing history storing unit 306 based on at least one of the name of the disease/injury, the name of the site, the name of the doctor and the type of the patient that were obtained by the image acquisition unit 308 from the electronic medical chart (Step S402). In this search, the image-processing details extraction unit 310 may search for the details of image processing based on the name of the disease/injury only or based on the name of the disease/injury and the name of the doctor only, in accordance with the instruction input by the doctor, for example.

In a case where desired details of image processing were not found in the search by the image-processing details extraction unit 310 (Step S404-N), the display unit 314 displays the medical image obtained by the image acquisition unit 308 (Step S414). The doctor then performs image processing for the medical image manually by means of the input unit 316 while observing the medical image displayed by the display unit 314 (Step S416). The doctor then examines the medical image displayed by the display unit 314 so as to conduct diagnosis, and thereafter inputs the diagnosis in medical chart information by using the input unit 316 (Step S418). Then, the image-processing history storing unit 306 stores the details of the image processing that was performed for the medical image at the time at which the doctor inputted the diagnosis based on that medical image, together with the name of the disease/injury, the name of the site, the name of the doctor and the type of the patient (Step S420).

In a case where desired details of image processing were not found in the search by the image-processing details extraction unit 310 (Step S404-N), the display unit 314 may present a display for allowing the doctor to select details of image processing stored in the image-processing history storing unit 306. The doctor may select the details of image processing by referring to the name of the disease/injury, the name of the site, the name of the doctor and the type of the patient. Then, the image processing unit 312 may perform image processing based on the details of image processing thus selected. In this case, the image-processing history storing unit 306 counts the number of the used times corresponding to the selected details of the image processing.

In a case where the search by the image-processing history storing unit 310 founds a plurality of ways of image processing (Steps S404-Y and S405-Y), for example, in a case where a plurality of ways of image processing respectively corresponding to a plurality of names of doctors were found in the search based on the name of the disease/injury and the name of the site only, the image-processing details extraction unit 310 selects one way of image processing for which the number of the used times is the largest from a plurality of stored ways of image processing that correspond to the information used as the search condition such as the name of the disease/injury, the name of the site, the name of the doctor and/or the type of the patient (Step S406). The image-processing details extraction unit 310 then extracts the selected way of image processing, i.e., the selected details of image processing (Step S407).

Moreover, in a case where the search by the image-processing details extraction unit 310 founds one way of image processing (Steps S404-Y and Step S405-N), the image-processing details extraction unit 310 extracts that way of image processing, i.e., the found details of image processing that correspond to the information used as the search condition such as the name of the disease/injury, the name of the site, the name of the doctor and the type of the patient, from the image-processing history storing unit 306 (Step S407). Then, the image processing unit 312 automatically performs image processing having the details that are the same as those of image processing thus extracted, for the medical image obtained by the image acquisition unit 308 from the electronic medical chart database 304 (Step S408).

For example, the image processing unit 312 selects an affected area within the medical image obtained by the image acquisition unit 308 by image matching or the like using a template image that was prepared and stored for each site in advance. The image processing unit 312 then magnifies the affected area thus selected, based on the magnifying power extracted by the image-processing details extraction unit 310. Moreover, the image processing unit 312 performs an operation related to the gray scale and an operation related to the frequency for the medical image based on the details of those operations extracted by the image-processing details extraction unit 310. In a case where the name of the disease/injury is a fracture and the name of the site is an ankle, the image-processing details extraction unit 310 specify the affected area by using a template image for the ankle, determines a dynamic range so as to allow the fracture to be clearly displayed, and enhances high spatial frequency components.

Then, the display unit 314 displays the medical image for which the image processing was performed by the image processing unit 312 together with the electronic medical chart (Step S410). The doctor examines the medical image thus displayed and conducts diagnosis. Subsequently, the doctor inputs the diagnosis in the electronic medical chart by means of the input unit 316 (Step S412).

The display unit 314 may display the medical image obtained by the image acquisition unit 308 before image processing is performed. In this case, the display unit 314 may display the medical image during the image processing as needed, and the doctor may input various instructions related to the image processing, such as an instruction for stopping or pausing the image processing or the like, by means of the input unit 316. Moreover, the doctor may further manipulate the medical image for which the image processing has been performed, manually by means of the input unit 316.

According to the image processing apparatus 300 of the present embodiment, image processing that was performed by the doctor for the medical image is automatically performed for a newly obtained medical image. Therefore, the doctor can save the efforts of performing the image processing in the same way in every examination of the medical image. Also, image processing can be automatically performed in an appropriate manner. Moreover, even if the doctor examines a certain type of a medical image for which that doctor does not have much experience, the doctor can learn the way of image processing by referring to the ways of the image processing performed by other doctors. Therefore, it is possible to prevent the image processing from being performed for the medical image inappropriately, thus wrong diagnosis can be avoided.

As is apparent from the above, according to an image processing apparatus of the present invention, it is possible to automatically perform image processing for a medical image in an appropriate manner.

Although the present invention has been described by way of exemplary embodiments, it should be understood that those skilled in the art might make many changes and substitutions without departing from the spirit and the scope of the present invention which is defined only by the appended claims.

What is claimed is:

1. An image processing apparatus comprising:
an image-processing history storing unit operable to store details of image processing performed for a medical image of a patient to correspond to a name of said patient;
an image acquisition unit operable to newly obtain a name of a patient and a medical image in such a manner that they correspond to each other;
an image-processing details extraction unit operable to extract said details of said image processing stored in said image-processing history storing unit to correspond to said name of said patient newly obtained by said image acquisition unit; and
an image processing unit operable to perform image processing having details that are the same as said details of said image processing thus extracted, for said medical image newly obtained by said image acquisition unit.

2. An image processing apparatus as claimed in claim 1, wherein said image-processing history storing unit stores said medical image of said patient in such a manner that said medical image correspond to said name of said patient and a name of a site of said patient,
said image acquisition unit further obtains a name of a site newly, and
said image-processing details extraction unit extracts said details of said image processing stored in said image-processing history storing unit to correspond to said name of said patient and said name of said site that were newly obtained by said image acquisition unit.

3. An image processing apparatus as claimed in claim 1, wherein said image-processing history storing unit stores said details of said image processing that was performed for said medical image when diagnosis based on said medical image was input in an electronic medical chart.

4. An image processing apparatus as claimed in claim 1, wherein said image-processing history storing unit stores details of an operation related to a frequency that was performed for said medical image in order to diagnose a disease/injury of said patient, as said details of said image processing.

5. An image processing apparatus as claimed in claim 1, wherein said image-processing history storing unit stores a range of an intensity of brightness of said medical image that was selected for diagnosis of a disease/injury of said patient, as said details of said image processing.

6. An image processing apparatus comprising:
an image-processing history storing unit operable to store details of image processing performed for a medical image of a patient in such a manner that said details of said image processing correspond to a name of a disease/injury of said patient that was diagnosed;
an image acquisition unit operable to newly obtain a name of a disease/injury and a medical image;
an image-processing details extraction unit operable to extract said details of said image processing stored in said image-processing history storing unit in such a manner that said details of said image processing correspond to said name of said disease/injury newly obtained by said image acquisition unit; and
an image processing unit operable to perform image processing having details that are the same as extracted said details of said image processing, for said medical image newly obtained by said image acquisition unit.

7. An image processing apparatus as claimed in claim 6, wherein said image-processing history storing unit stores said details of said image processing in such a manner that said details of said image processing correspond to said name of said disease/injury as well as a name of a site,
said image acquisition unit further obtains a name of a site to correspond to said medical image newly obtained, and
said image-processing details extraction unit extracts said details of said image processing stored in said image-processing history storing unit, to correspond to said name of said disease/injury and said name of said site that were newly obtained by said image acquisition unit.

8. An image processing apparatus as claimed in claim 6, wherein said image-processing history storing unit stores said details of said image processing in such a manner that said details of said image processing correspond to said name of said disease/injury as well as a type of said patient,
said image acquisition unit further obtains a type of a patient to correspond to said medical image newly obtained, and
said image-processing details extraction unit extracts said details of said image processing stored in said image-processing history storing unit, to correspond to said name of said disease/injury and said type of said patient that were newly obtained by said image acquisition unit.

9. An image processing apparatus as claimed in claim 6, wherein said image-processing history storing unit stores said details of said image processing in such a manner that said details of said image processing correspond to said name of said disease/injury as well as a name of a doctor who performed said image processing,
said image acquisition unit further obtains a name of a doctor to correspond to said medical image newly obtained, and
said image-processing details extraction unit extracts said details of said image processing stored in said image-processing history storing unit, to correspond to said name of said disease/injury and said name of said doctor that were newly obtained by said image acquisition unit.

10. An image processing apparatus as claimed in claim 6, wherein said image-processing details extraction unit extracts one way of said image processing for which a number of used times is the largest, from a plurality of ways of said image processing stored in said image-processing history storing unit to correspond to said name of said disease/injury newly obtained by said image acquisition unit.

11. An image processing apparatus as claimed in claim 6, wherein said image-processing history storing unit stores said details of said image processing when diagnosis based on said medical image was input in an electronic medical chart.

12. An image processing apparatus as claimed in claim 6, wherein, when an electronic medical chart was selected,
said image acquisition unit obtains said medical image and said name of said disease/injury that are attached to said selected electronic medical chart,
said image-processing details extraction unit extracts said details of said image processing that are stored to correspond to said name of said disease/injury newly obtained by said image acquisition unit from said electronic medical chart, from said image-processing history storing unit, and
said image processing unit performs image processing having details that are the same as those extracted, for said medical image newly obtained by said image acquisition unit from said electronic medical chart.
